(19) United States
(12) Patent Application Publication
(10) Pub. No.: US 2013/0070811 A1
(43) Pub. Date: Mar. 21, 2013

(54) TRANSMISSION/RECEPTION APPARATUS AND METHOD FOR FILTERED MULTI-TONE SYSTEM

(71) Applicants: Nam Il KIM, Daejeon (KR); Ok Sun PARK, Daejeon (KR); Hyung Gu HWANG, Daejeon (KR); Jae Kyung LEE, Daejeon (KR); Dae Ho KIM, Daejeon (KR)

(72) Inventors: Nam Il KIM, Daejeon (KR); Ok Sun PARK, Daejeon (KR); Hyung Gu HWANG, Daejeon (KR); Jae Kyung LEE, Daejeon (KR); Dae Ho KIM, Daejeon (KR)

(73) Assignee: Electronics and Telecommunications Research Institute, Daejeon (KR)

(21) Appl. No.: 13/611,847

(22) Filed: Sep. 12, 2012

(30) Foreign Application Priority Data
Sep. 20, 2011 (KR) 10-2011-0094772
May 2, 2012 (KR) 10-2012-0046317

(51) Int. Cl. H04B 1/00

(52) U.S. Cl. 375/136; 375/135; 375/E01.033

(57) ABSTRACT

Disclosed are an apparatus for transmitting multi-carrier signals, including: a signal spreading unit configured to generate band-spread signals through band spreading of a plurality of symbol-mapped signals; and a modulation unit configured to generate a modulation signal by mixing the band-spread signals with a plurality of sub-carriers and adding up the mixed band-spread signals, and a method for transmitting multi-carrier signals.

### CROSS-REFERENCE TO RELATED APPLICATIONS

This application claims priority to and the benefit of Korean Patent Application No. 10-2011-0094772 filed in the Korean Intellectual Property Office on Sep. 20, 2011 and 10-2012-0046317 filed in the Korean Intellectual Property Office on May 2, 2012, the entire contents of which are incorporated herein by reference.

### TECHNICAL FIELD

The present invention relates to an apparatus and a method of data transmission/reception, and more particularly, to an apparatus and a method for improving a characteristic of a peak-to-average power ratio (PAPR) of a transmission signal in a multi-carrier transmission type communication system.

### BACKGROUND ART

Various methods for multi-carrier transmission are provided, and the multi-carrier transmission schemes can be generally classified into an overlapped multi-carrier transmission scheme and a non-overlapped multi-carrier transmission scheme according to overlapping of sub-frequency bands in dividing a frequency spectrum.

A filtered multi-tone (FMT) modulation scheme is used to transmit data in a terrestrial trunked radio (TETRA) system of a standard document of ETSI EN 300 392-2 and a VHF data system of a standard document of Rec.ITU-R M.1842-1.

In the FTM modulation scheme as a scheme of transmitting a modulation signal by using M sub-carriers, a signal transmitted to each of the sub-carriers passes through a pulse shaping filter in which a roll-off factor has ‘a’. When a transmission symbol rate of a data symbol transmitted to each sub-carrier is 1/T and the number of the sub-carriers is M, a total data symbol transmission rate is M/T. In this case, an interval of the sub-carriers is set to prevent signals transmitted as the sub-carriers from being overlapped by considering the roll-off factor of the pulse shaping filter.

That is, in the FMT system, the length of a filter extends throughout several symbol cycles in a time domain and performance deteriorates by intersymbol interference (ISI) in a multi-path environment by the use of the filter during a long cycle, unlike orthogonal frequency division multiplexing (OFDM).

In the FMT system, by bandpass-filtering sub-channel signals, frequencies are not overlapped among sub-channels, unlike the OFDM. A cycle prefix may not be used, and frequency efficiency is higher than the OFDM by the use of a small number of guard bands. However, the FMT system has high complexity by filtering for each sub-channel.

### SUMMARY OF THE INVENTION

A multi-carrier transmission type transmission system has a disadvantage in that a PAPR increases as compared with a single-frequency system because multiple sub-carrier signals are overlapped and transmitted.

An exemplary embodiment of the present invention provides an apparatus for transmitting multi-carrier signals, including: a signal spreading unit configured to generate band-spread signals through band spreading of a plurality of symbol-mapped signals; and a modulation unit configured to generate a modulation signal by mixing the band-spread signals with a plurality of sub-carriers and adding up the mixed band-spread signals.

The signal spreading unit may band-spread a plurality of symbol-mapped data by using fast Fourier transform (FFT).

The signal spreading unit may band-spread a plurality of symbol-mapped data by using discrete Fourier transform (DFT).

Another exemplary embodiment of the present invention provides an apparatus for receiving multi-carrier signals, including: a demodulation unit configured to demodulate received multi-carrier signals for each of sub-carriers corresponding thereto; and a signal inverse spreading unit configured to inversely spread the respective demodulated sub-carrier signals.

The signal inverse spreading unit may inversely spread the respective demodulated sub-carrier signals by using inverse fast Fourier transform (IFFT).

The signal inverse spreading unit may inversely spread the respective demodulated sub-carrier signals by using inverse discrete Fourier transform (IDFT).

Yet another exemplary embodiment of the present invention provides a method for transmitting multi-carrier signals, including: generating band-spread signals through band spreading of a plurality of symbol-mapped signals; and generating a modulation signal by mixing the band-spread signals with a plurality of sub-carriers and adding up the mixed band-spread signals.

In the generating of band-spread signals, a plurality of symbol-mapped data may be band-spread by using fast Fourier transform (FFT).

In the generating of band-spread signals, a plurality of symbol-mapped data may be band-spread by using discrete Fourier transform (DFT).

Still another exemplary embodiment of the present invention provides a method for receiving multi-carrier signals, including: demodulating received multi-carrier signals for each of sub-carriers corresponding thereto; and inversely spreading the respective demodulated sub-carrier signals.

In the inversely spreading of the signals, the respective demodulated sub-carrier signals may be inversely spread by using inverse fast Fourier transform (IFFT).

In the inversely spreading of the signals, the respective demodulated sub-carrier signals may be inversely spread by using inverse discrete Fourier transform (IDFT).

An object of the present invention is to decrease a PAPR of a transmission signal in a multi-carrier transmission system. The decrease in the PAPR may decrease non-linear signal distortion of a high-output power amplifier, and as a result, an interference signal and interference between adjacent channels within a band of a multi-carrier system may be decreased.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a reference diagram for describing a filtered multi-tone (FMT) system in the related art.

FIG. 2 illustrates a spectrum of an output signal in the FMT system in the related art.

FIG. 3 is a block diagram for describing a transmission apparatus in an FMT system according to an exemplary embodiment of the present invention.

FIG. 4 is a block diagram for describing the FMT system according to the exemplary embodiment of the present invention.

FIG. 5 is a reference diagram for comparing PAPR characteristics in an FMT type transmission system according to the exemplary embodiment of the present invention.

FIG. 6 is a block diagram for describing a reception apparatus in the FMT type transmission system of the present invention.

FIG. 7 is a reference diagram for describing an FMT type reception system of the present invention.

FIG. 8 is a flowchart for describing a transmission method in an FMT system according to an exemplary embodiment of the present invention.

FIG. 9 is a flowchart for describing a reception method in an FMT system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. In describing the present invention, well-known functions or constructions will not be described in detail since they may unnecessarily obscure the understanding of the present invention.

In exemplary embodiments described below, components and features of the present invention are combined with each other in a predetermined pattern. Each component or feature may be considered to be optional unless stated otherwise. Each component or feature may not be combined with other components or features. Some components and/or features are combined with each other to configure the exemplary embodiments of the present invention. The order of operations described in the exemplary embodiments of the present invention may be modified. Some components or features of any exemplary embodiment may be included in other exemplary embodiments or substituted with corresponding components or features of other exemplary embodiments.

The exemplary embodiments of the present invention may be implemented through various means. For example, the exemplary embodiments of the present invention may be implemented by hardware, firmware, software, or combinations thereof.

In the case of implementation by hardware, a method according to the exemplary embodiment of the present invention may be implemented by one or more application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, and the like.

In the case of implementation by firmware or software, the method according to the exemplary embodiments of the present invention may be implemented in the form of a module, a process, or a function of performing the functions or operations described above. Software codes may be stored in a memory unit and driven by a processor. The memory unit is positioned inside or outside of the processor to transmit and receive data to and from the processor by a previously known various means.

Predetermined terms used in the following description are provided to help understanding the present invention and the use of the predetermined terms may be modified into different forms without departing from the spirit of the present invention.

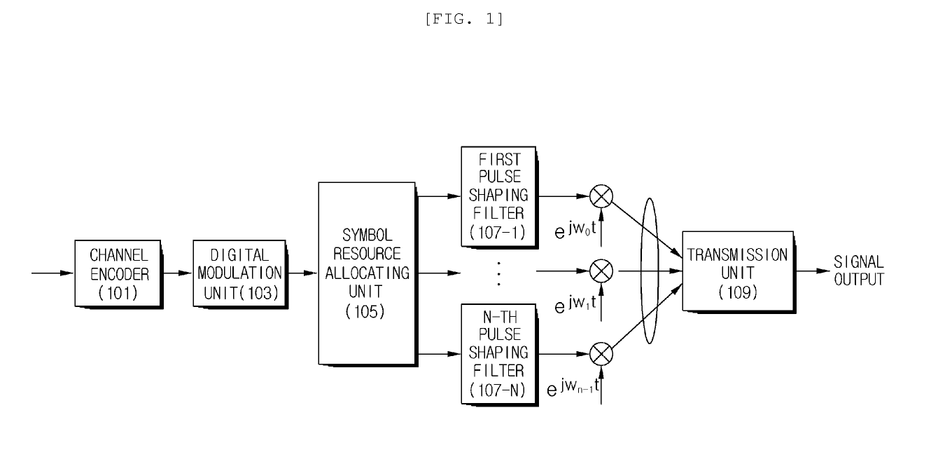

Referring to FIG. 1, an FMT transmission system among multi-carrier transmission schemes in the related art will be described.

A multi-carrier transmission system in the related art includes a channel encoder 101, a digital modulation unit 103, a symbol resource allocating unit 105, a pulse shaping filter 107, and a transmission unit 109.

The channel encoder 101 is used to encode transmission data of a transmitter in order to detect and restore an error of data received from a receiver. The channel encoder 101 converts the transmission data into parallel data as many as sub-carrier signals.

The digital modulation unit 103 digital-modulates a data symbol configured by binary data to be transmitted through a channel to generate a digital modulation symbol. In this case, types of the digital modulation performed by the digital modulation unit 103 include binary phase shift keying (BPSK), quadrature phase shift keying (QPSK), quadrature amplitude modulation (QAM), 16-QAM, 64-QAM, and the like. The digital modulation unit may be expressed as a symbol mapping unit.

The symbol resource allocating unit 105 allocates resources to time and frequency domains in order to transmit the symbol modulated by the digital modulation unit 103 to a wired or wireless section.

The pulse shaping filter 107 pulse-shapes M sub-carriers during each time symbol section allocated with a symbol resource by a filter having a predetermined roll-off factor.

In the transmission unit 109, an output signal passing through a pulse shaping filter goes through sub-carrier transition and M signals in which sub-carriers are transited are added up in each time sample and thereafter, goes through frequency transition to a wired/wireless transmission frequency to be output to an output signal of the transmission unit.

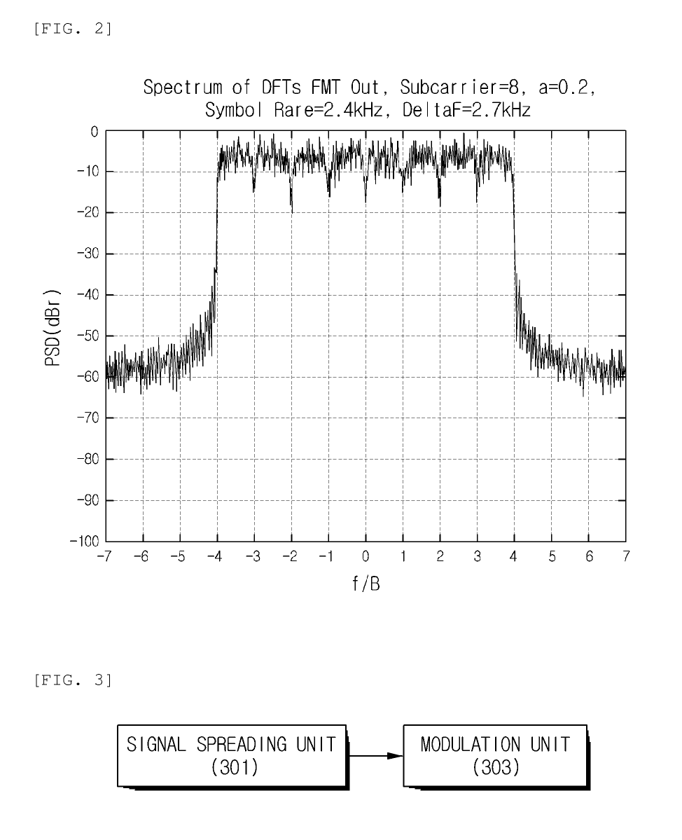

FIG. 2 illustrates a spectrum of the output signal when the number of the sub-carriers is 8, the roll-off factor is 0.2, a transmission rate of the data symbol transmitted for each sub-carrier is 2400 symbol/sec, and an interval between sub-carrier frequencies is 2700 KHz, in the FMT type transmission system in the related art.

Referring to FIG. 3, a transmission apparatus in the multi-carrier transmission type communication system according to an exemplary embodiment of the present invention will be described. The FMT system according to the exemplary embodiment of the present invention is digitally implemented and has a structure in which a transmitter and a receiver are simplified by using fast Fourier transform or inverse fast Fourier transform. The multi-subcarrier transmission scheme includes an OFDM scheme and an FMT scheme. The transmission apparatus includes a signal spreading unit 301 and a modulation unit 303.

The signal spreading unit 301 spreads a signal with respect to a plurality of symbol-mapped data.

According to the exemplary embodiment of the present invention, the signal spreading unit spreads the signal with respect to the plurality of symbol-mapped data by using the fast Fourier transform (FFT). That is, an FFT operating unit generates N FFT symbols by performing the fast Fourier transform (FFT).

According to another exemplary embodiment of the present invention, the signal spreading unit spreads the signal with respect to the plurality of symbol-mapped data by using discrete Fourier transform.

The modulation unit 303 converts the plurality of symbol-mapped data in which the signal is spread into a symbol of a time domain and modulates the symbols to sub-carriers corresponding thereto, respectively.

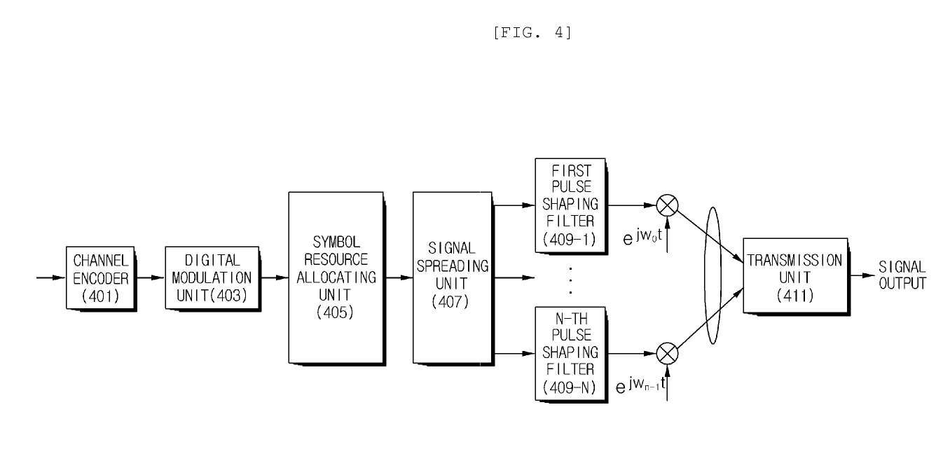

Referring to FIG. 4, the FMT transmission system including the transmission apparatus according to the exemplary embodiment of the present invention will be described. The FMT transmission system includes a channel encoder 401, a digital modulation unit 403, a symbol resource allocating unit 405, a signal spreading unit 407, a pulse shaping filter 409, and a transmission unit 411.

The channel encoder 401 encodes the transmission data of the transmitter.

The digital modulation unit 403 digital-modulates the data symbol configured by the binary data to be transmitted through the channel to generate the digital modulation symbol.

The symbol resource allocating unit 405 allocates the modulated symbol to the time and frequency domains as the resource.

The signal spreading unit 407 spreads the signal with respect to the plurality of symbol-mapped data. That is, the signal spreading unit 407 spreads the signal by using the fast Fourier transform (FFT) or the discrete Fourier transform (DFT) with respect to the plurality of symbol-mapped data.

The pulse shaping filter 409 pulse-shapes the plurality of symbol-mapped data.

The transmission unit 411 performs frequency-transition of the signal passing through the pulse shaping filter 409 and outputs the frequency-transited signal.

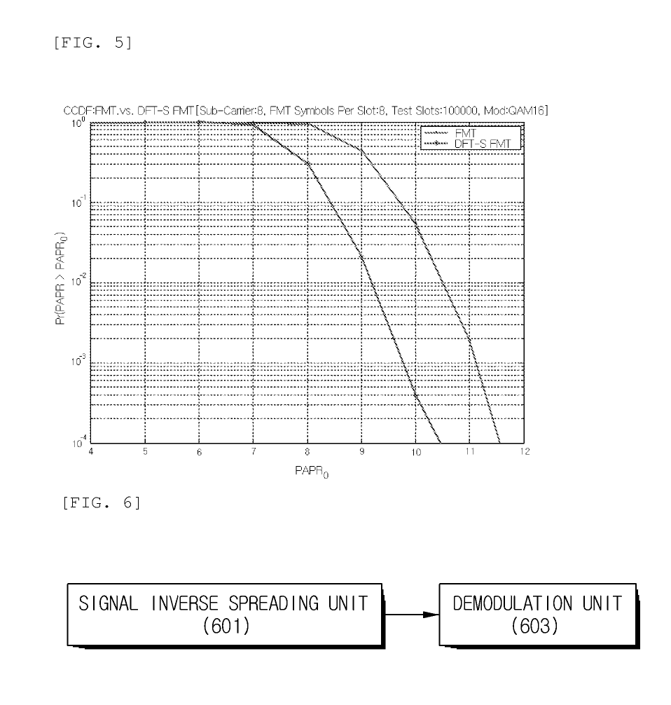

Referring to FIG. 5, a graph of comparing PAPR characteristics in the FMT type transmission system according to the exemplary embodiment of the present invention will be described. In the FMT type transmission system, when the transmission rate of the data symbol is 2400 symbol/sec and the interval between the sub-carriers is 2.7 KHz, it can be seen that the FMT transmission system according to the present invention provides a PAPR decrease effect of approximately 1.3 dB at CCDF 1%.

Referring to FIG. 6, a reception apparatus in the FMT type transmission system according to the exemplary embodiment of the present invention will be described. The reception apparatus includes a signal inverse spreading unit 601 and a demodulation unit 603.

The signal inverse spreading unit 601 inversely spreads the respective received sub-carrier signals.

The demodulation unit 603 demodulates the inversely spread multi-carrier signals for each of the sub-carriers corresponding thereto.

According to the exemplary embodiment of the present invention, the signal inverse spreading unit 603 inversely spreads the respective demodulated sub-carrier signals by using the inverse fast Fourier transform or inverse discrete Fourier transform.

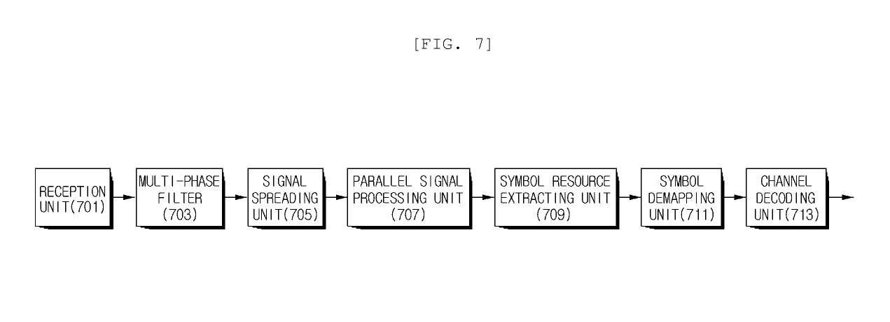

Referring to FIG. 7, a reception apparatus in the FMT type transmission system according to the exemplary embodiment of the present invention will be described.

A reception unit 701 receives a signal transmitted from a transmission apparatus.

A multi-phase filter 703 generates M parallel signals based on the signal received from the reception unit 701.

A signal spreading unit 705 spreads M signals by using the fast Fourier transform (FFT) or the discrete Fourier transform (DFT).

A parallel signal processing unit 707 performs the inverse fast Fourier transform (IFFT) when the signal spreading unit performs the fast Fourier transform (FFT) of M parallel signals which go through signal spreading and performs the inverse discrete Fourier transform (IDFT) when the signal spreading unit performs the discrete Fourier transform (FFT) of the parallel signals to process the parallel signals.

A symbol resource extracting unit 709 extracts a symbol resource from the signal processed by the parallel signal processing unit 707.

A symbol demapping unit 711 modulates a digital modulation signal to a binary data symbol.

A channel decoding unit 713 transmits upper layer data by decoding the data of the receiver.

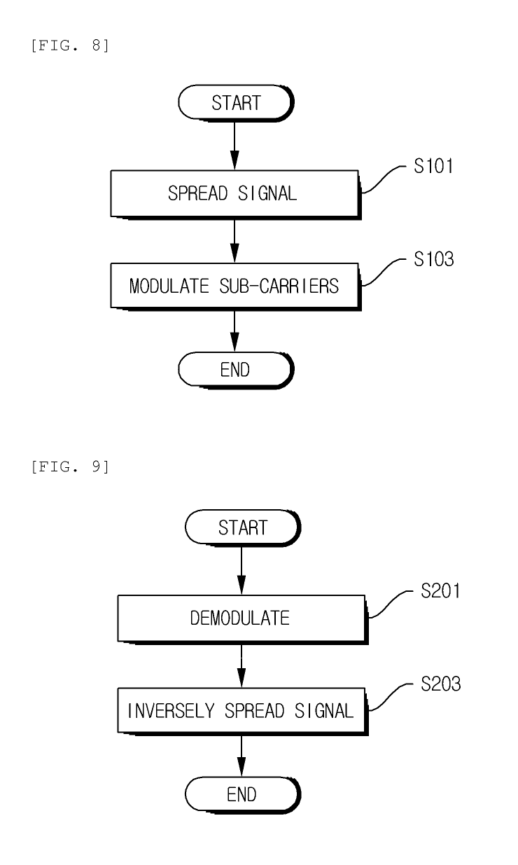

Referring to FIG. 8, a transmission method in the FMT type transmission system according to the exemplary embodiment of the present invention will be described. In the FMT type transmission system, the same content as the transmission apparatus is replaced with the above content.

In step S100, a signal is spread with respect to a plurality of symbol-mapped data.

According to the exemplary embodiment of the present invention, the signal is spread with respect to the plurality of symbol-mapped data by using the fast Fourier transform (FFT) or the discrete Fourier transform.

In step S110, the plurality of symbol-mapped data which is signal-spread is converted into the symbol of the time domain to be modulated to the corresponding sub-carriers.

Referring to FIG. 9, a reception method in an FMT type transmission system according to an exemplary embodiment of the present invention will be described. In the FMT type transmission system, the same content as the reception apparatus is replaced with the above content.

In step S200, received multi-carrier signals with respect to a plurality of symbol-mapped data are demodulated for each of the corresponding sub-carriers.

In step S210, the respective demodulated sub-carrier signals are inversely spread.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for transmitting multi-carrier signals, comprising:
a signal spreading unit configured to generate band-spread signals through band spreading of a plurality of symbol-mapped signals; and
a modulation unit configured to generate a modulation signal by mixing the band-spread signals with a plurality of sub-carriers and adding up the mixed band-spread signals.

2. The apparatus of claim 1, wherein:
the signal spreading unit band-spreads a plurality of symbol-mapped data by using fast Fourier transform (FFT).

3. The apparatus of claim 1, wherein:
the signal spreading unit band-spreads the plurality of symbol-mapped data by using discrete Fourier transform (DFT).

4. An apparatus for receiving multi-carrier signals, comprising:
a demodulation unit configured to demodulate received multi-carrier signals for each of corresponding sub-carriers; and
a signal inverse spreading unit configured to inversely spread the respective demodulated sub-carrier signals.

5. The apparatus of claim 4, wherein:
the signal inverse spreading unit inversely spreads the respective demodulated sub-carrier signals by using inverse fast Fourier transform (IFFT).

6. The apparatus of claim 4, wherein:
the signal inverse spreading unit inversely spreads the respective demodulated sub-carrier signals by using inverse discrete Fourier transform (IDFT).

7. A method for transmitting multi-carrier signals, comprising:
generating band-spread signals through band spreading of a plurality of symbol-mapped signals; and
generating a modulation signal by mixing the band-spread signals with a plurality of sub-carriers and adding up the mixed band-spread signals.

8. The method of claim 7, wherein:
in the generating of band-spread signals, a plurality of symbol-mapped data is band-spread by using fast Fourier transform (FFT).

9. The method of claim 7, wherein:
in the generating of band-spread signals, the plurality of symbol-mapped data is band-spread by using discrete Fourier transform (DFT).

10. A method for receiving multi-carrier signals, comprising:
demodulating received multi-carrier signals for each of corresponding sub-carriers; and
inversely spreading the respective demodulated sub-carrier signals.

11. The method of claim 10, wherein:
in the inversely spreading of the signals, the respective demodulated sub-carrier signals are inversely spread by using inverse fast Fourier transform (IFFT).

12. The method of claim 10, wherein:
in the inversely spreading of the signals, the respective demodulated sub-carrier signals are inversely spread by using inverse discrete Fourier transform (IDFT).
